(19) United States
(12) Patent Application Publication
(10) Pub. No.: US 2023/0389520 A1
(43) Pub. Date: Dec. 7, 2023

(54) Pet Toy and Sound Generator

(71) Applicant: Bencoo, Inc. DBA ZippyPaws, Chino, CA (US)

(72) Inventor: Jennifer Glaser, Pasadena, CA (US)

(21) Appl. No.: 17/831,326

(22) Filed: Jun. 2, 2022

(51) Int. Cl. A01K 15/02

(52) U.S. Cl. CPC A01K 15/025

(57) ABSTRACT

The present application discloses a pet toy. The pet toy comprises a body and a sound generator. The body comprises at least one body hole. The sound generator is partially passed through the body hole, wherein the sound generator comprises a top sound maker, a bottom sound maker and a sleeve. The sleeve is coupled between the top sound maker and the bottom sound maker. Wherein the sound generator is capable of generating sound when air volume inside the body is changed, a frequency of the sound is over 20,000 Hz. Specifically, the frequency of the sound is over 20,000 Hz and below 45,000 Hz. The sound generator as above is also disclosed.

### TECHNICAL FIELD OF THE INVENTION

The present application generally relates to pet toys, and more particularly, to a pet toy and a sound generator.

### BACKGROUND OF THE INVENTION

Generally, an electronic device is built in the pet toy for sound-making. However, it is required for the user to replace the battery frequently. In addition, the leakage of battery may bring contamination and it is also dangerous for the pet. Furthermore, the cost is high since the electronic structure is complicated and easily to be broken.

Another kind of pet toy uses air flow to create sound. In current market, the range of sounding decibels for such pet toy is below 85 dBA or 120 dBC in 9.8 inches of distance. However, different from the electronic type of pet toy which could customize the sound, the air flow type of pet toy is noisy for humans.

Therefore, a need remains for a pet toy and a sound generator to generate sound via an easier, cheaper and quieter way.

### SUMMARY OF THE INVENTION

The present application discloses a pet toy and a sound generator to generate sound via an easier, cheaper and quieter way.

The pet toy of the present application comprises a body and a sound generator. The body comprises at least one body hole. The sound generator is partially passed through the body hole, wherein the sound generator comprises a top sound maker, a bottom sound maker and a sleeve. The sleeve is coupled between the top sound maker and the bottom sound maker. Wherein the sound generator is capable of generating sound when air volume inside the body is changed, a frequency of the sound is over 20,000 Hz.

In various exemplary embodiments, wherein the frequency of the sound is over 20,000 Hz and below 45,000 Hz.

In various exemplary embodiments, wherein the sleeve comprises at least one sleeve hole. Specifically, the sleeve comprises four sleeve holes.

In various exemplary embodiments, wherein the top sound maker is defined by a top flat end and a top conical end. The top sound maker comprises a top outer body, a top cylinder, at least one top connector and a top central rod. The at least one top connector connects the top outer body and the top cylinder. The top central rod is coupled to the top cylinder and protruded from the top conical end. Wherein a top airflow passage is formed between the top central rod, the top outer body and the sleeve.

Specifically, the top sound maker comprises four top connectors; the top cylinder is hollow; the top sound maker further comprises a top edge located at the top flat end; the top outer body, and the top cylinder, the at least one top connector and the top central rod are molded integrally.

In various exemplary embodiments, wherein the bottom sound maker is defined by a bottom flat end and a bottom conical end. The bottom sound maker comprises a bottom outer body, a bottom cylinder and at least one bottom connector. Wherein the bottom cylinder is hollow, a bottom airflow passage is formed between the bottom cylinder and the sleeve. The at least one bottom connector connects the bottom outer body and the bottom cylinder.

Specifically, the bottom sound maker comprises four bottom connectors; the bottom sound maker further comprises a bottom edge located anywhere between the bottom flat end and the bottom conical end; and the bottom outer body, the bottom cylinder and the at least one bottom connector are molded integrally.

In various exemplary embodiments, wherein the body comprises a recess. The body comprises one hole located at the recess. The bottom sound maker is located at the recess partially.

The present application also discloses the sound generator as above. Specifically, the sound generator comprises a top sound maker, a bottom sound maker and a sleeve. The sleeve is coupled between the top sound maker and the bottom sound maker. Wherein the sound generator is capable of generating sound when air volume inside the body is changed, a frequency of the sound is over 20,000 Hz.

In various exemplary embodiments, wherein the frequency of the sound is over 20,000 Hz and below 45,000 Hz.

In various exemplary embodiments, wherein the top sound maker is defined by a top flat end and a top conical end. The top sound maker comprises a top cylinder, at least one top connector and a top central rod. The at least one top connector connects the top outer body and the top cylinder. The top central rod is coupled to the top cylinder and protruded from the top conical end. Wherein a top airflow passage is formed between the top central rod, the top outer body and the sleeve.

In various exemplary embodiments, wherein the bottom sound maker is defined by a bottom flat end and a bottom conical end. The bottom sound maker comprises a bottom outer body, a bottom cylinder and at least one bottom connector. Wherein the bottom cylinder is hollow, a bottom airflow passage is formed between the bottom cylinder and the sleeve. The at least one bottom connector connects the bottom outer body and the bottom cylinder.

The hearing threshold of humans and dogs are different. Humans hearing threshold is usually from 20 Hz to 20,000 Hz. However, animals have different hearing thresholds. For example, the hearing threshold of the dogs is usually around 67 Hz to 45,000 Hz, and even could be as high as 100,000 Hz, depending on breeds and ages.

Based on the above, the present application utilizes a mechanical structure rather than an electrical structure to create the sound, greatly reducing the production costs and manufacturing complexity.

In addition, based on the structure of the sound maker of the present application, the frequency of the sound created by the pet toy is higher than humans hearing threshold and only could be heard by animals such as dogs. Also, at a distance of 9.8 inches, the decibel of the created sound could be ignored by the humans, providing a quieter environment for humans.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 shows a pet toy of the present application.

FIG. 2 shows a sound generator and half of a body of the pet toy of the present application.

FIGS. 3A-3B show exploded views of the pet toy of the present application.

FIGS. 4A-4B shows cross-sectional and exploded views of the pet toy of the present application.

FIGS. 5A-5B shows cross-sectional views of the pet toy of the present application.

FIG. 6A shows a top view of the pet toy of the present application.

FIG. 6B is a cross-sectional view thereof taken along the line 6B-6B of FIG. 6A.

FIG. 6C is a cross-sectional view thereof taken along the line 6C-6C of FIG. 6A.

FIG. 7 shows a mechanism of air flowing.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

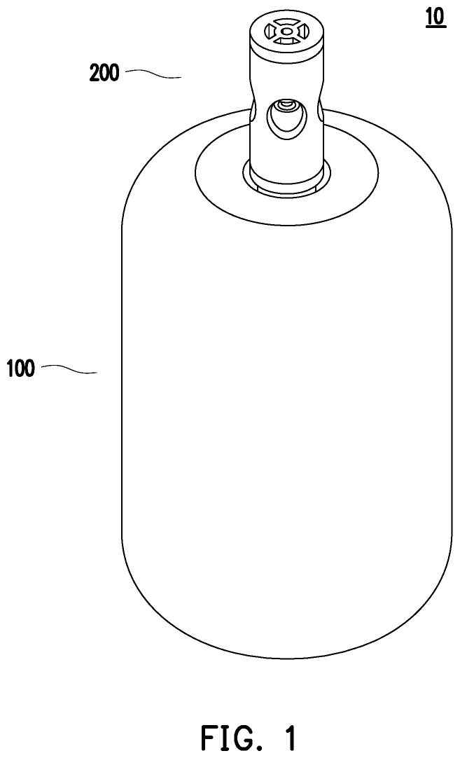

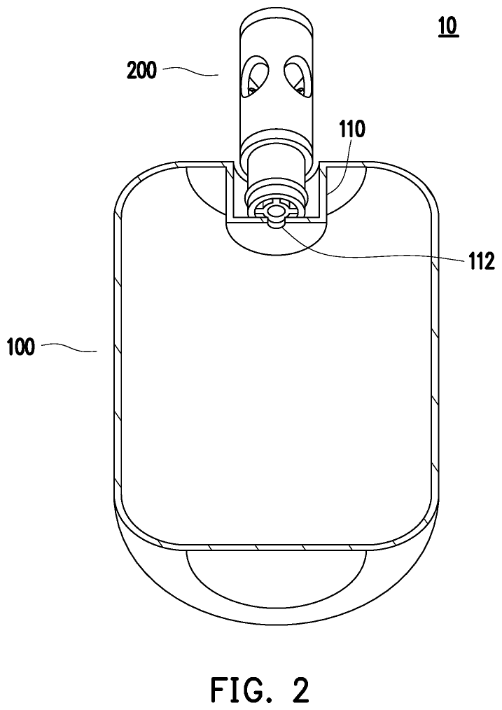

FIG. 1 shows a pet toy 10 of the present application. FIG. 2 shows a sound generator 200 and half of a body 100 of the pet toy of the present application.

Referring to FIGS. 1-2, the pet toy 10 of the present application comprises a body 100 and a sound generator 200. The overall shape of the body 100 is cylindrical as an example but is not limited as long as air volume inside the body 100 could be changed. The body 100 comprises a recess 110. In the present application, the recess 110 is cylindrical as an example but is not limited as long as the sound generator 200 could be fixed partially inside the recess 110. The body 100 further comprises at least one hole 112. In detail, the body 100 of the present application comprises one hole 112 located at the recess 110 as an example but is not limited. The body 100 may comprise not only one hole 112 and the hole 112 may be located anywhere at the body 100 as long as the airflow pass through the sound generator 200 when the air volume inside the body 100 is changed.

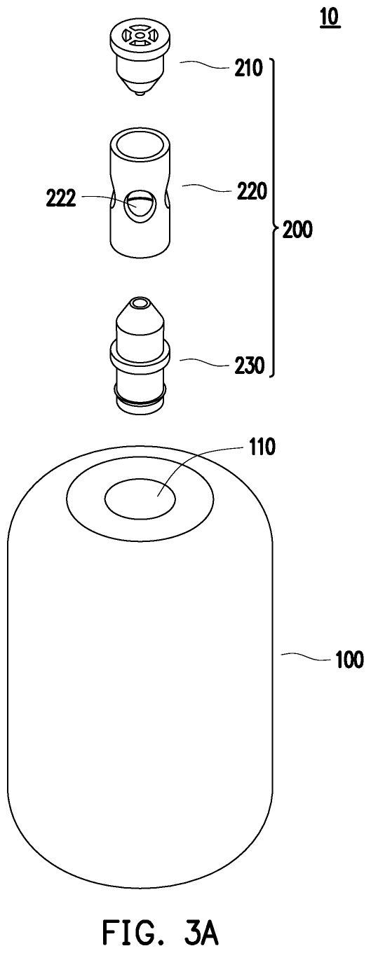

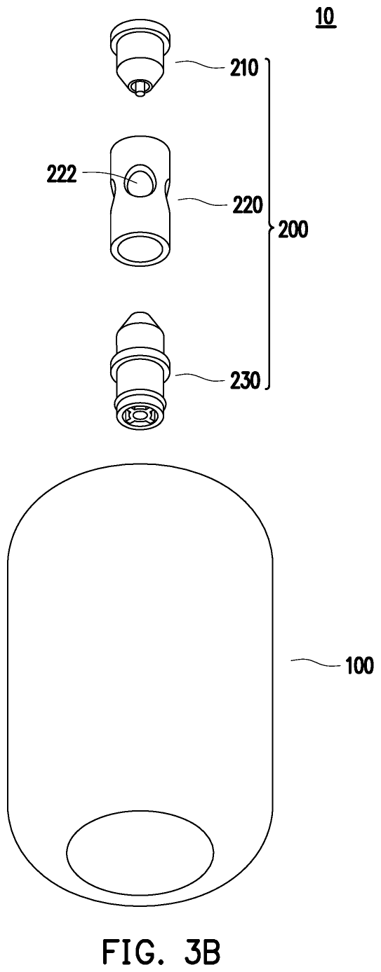

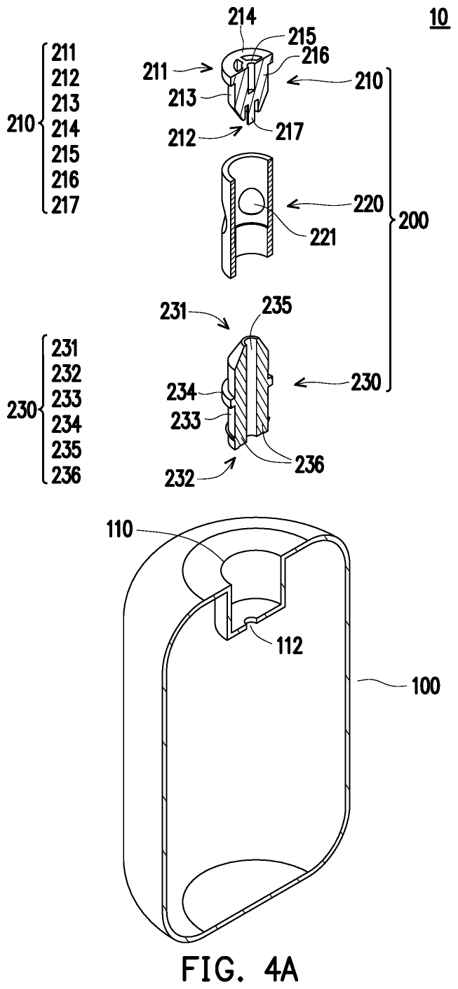

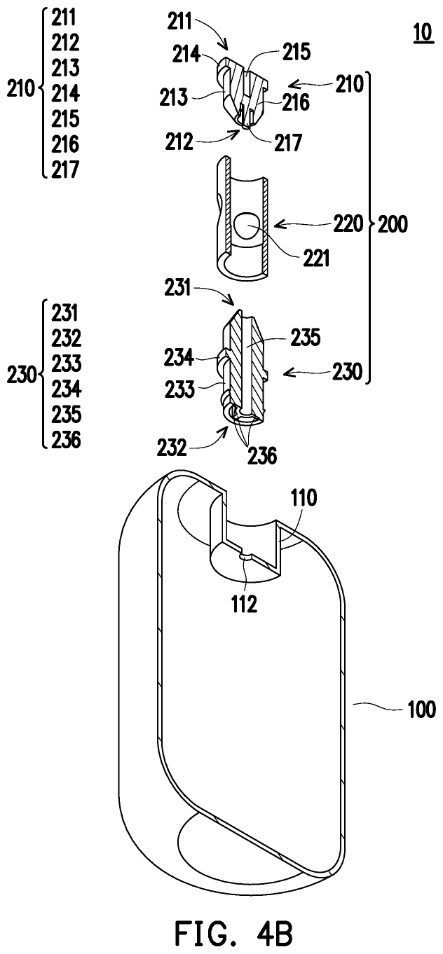

FIGS. 3A-3B show exploded views of the pet toy 10 of the present application. The sound generator 200 comprises a top sound maker 210, a sleeve 220 and a bottom sound maker 230. The details of the top sound maker 210 and the bottom sound maker 230 will be described later with FIGS. 4A-6C.

The sleeve 220 is coupled between the top sound maker 210 and the bottom sound maker 230. In the present application, the sleeve 220 is cylindrical as an example but is not limited as long as the top sound maker 210 and the bottom sound maker 230 could be partially inserted into it. The sleeve 220 comprises at least one sleeve hole 222. Specifically, the sleeve 220 of the present application comprises four sleeve holes 222 as an example but is not limited.

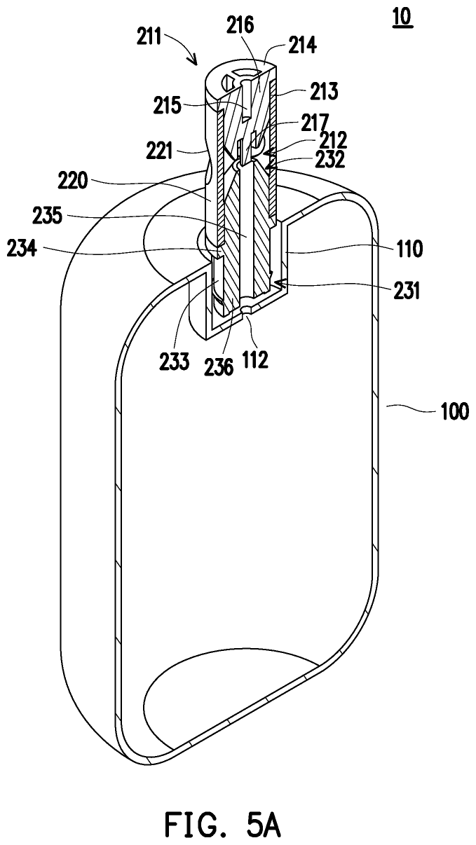

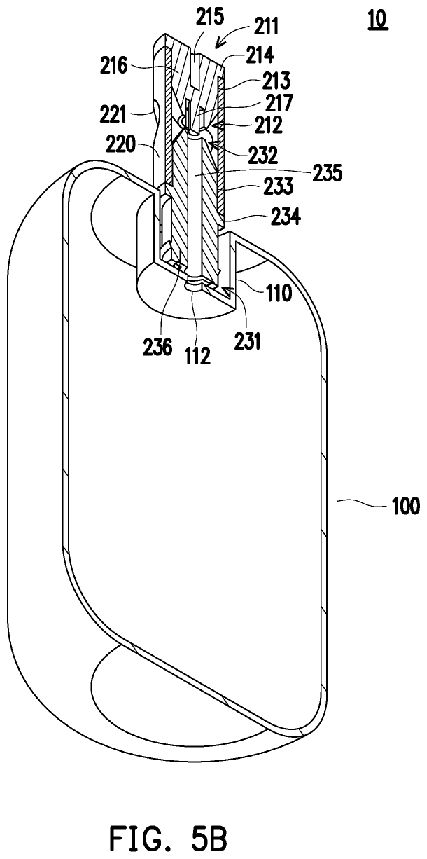

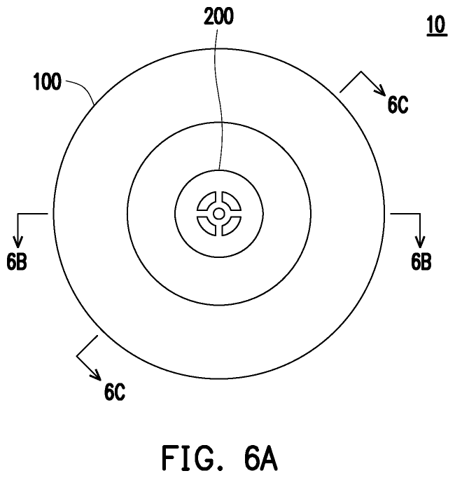

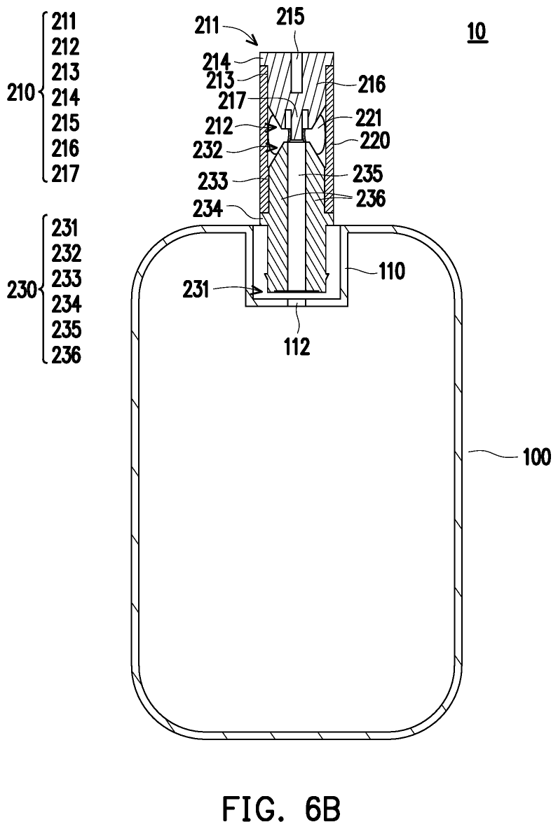

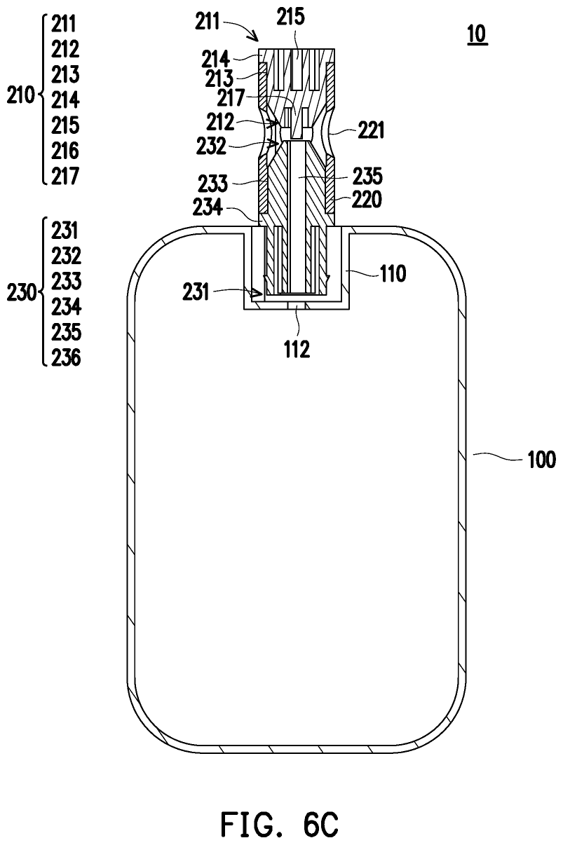

FIGS. 4A-4B shows cross-sectional and exploded views of the pet toy 10 of the present application. FIGS. 5A-5B shows cross-sectional views of the pet toy 10 of the present application. FIG. 6A shows a top view of the pet toy 10 of the present application. FIG. 6B is a cross-sectional view thereof taken along the line 6B-6B of FIG. 6A. FIG. 6C is a cross-sectional view thereof taken along the line 6C-6C of FIG. 6A.

Referring to FIGS. 4A-6C, the top sound maker 210 is defined by a top flat end 211 and a top conical end 212. The top sound maker 210 comprises a top outer body 213, a top edge 214, a top cylinder 215, at least one top connector 216 and a top central rod 217.

In the present application, an upper portion of the top outer body 213 is a hollow cylinder and a lower portion of the top outer body 213 is a hollow cone. As such, to be more specifically, the top outer body 213 is defined by the top flat end 211 and the top conical end 212.

The top edge 214 is located at the top flat end 211. When coupling the top sound maker 210 to the sleeve 220, the top sound maker 210 could be stuck by the top edge 214 without entirely falling into the sleeve 220.

The top cylinder 215 is coupled to the top outer body 213 by the at least one top connector 216. The top cylinder 215 of the present application is hollow as an example but is not limited. In the present application, the top sound maker 210 comprises four top connectors 216 as an example but is not limited as long as the top cylinder 215 could be coupled to the top outer body 213 stably.

The top central rod 217 is coupled to the top cylinder 215 and is protruded from the top conical end 212. The top central rod 217 in the present application is cylindrical as an example but is not limited. A top air flow passage is formed between the top central rod 217, the top outer body 213 and the sleeve 220.

In the present application, the top outer body 213, the top edge 214, the top cylinder 215, the top connectors 216 and the top central rod 217 are molded integrally. However, the top outer body 213, the top edge 214, the top cylinder 215, the top connectors 216 and the top central rod 217 could also be manufactured separately and assembled later together, as long as the above structure could be made.

The bottom sound maker 230 is defined by a bottom flat end 231 and a bottom conical end 232. The bottom sound maker 230 comprises a bottom outer body 233, a bottom edge 234, a bottom cylinder 235 and at least one bottom connector 236.

In the present application, a lower portion of the bottom outer body 233 is a hollow cylinder and an upper portion of the top outer body 213 is a hollow cone. As such, to be more specifically, the bottom outer body 233 is defined by the bottom flat end 231 and the bottom conical end 232.

The bottom edge 234 could be located anywhere between the bottom flat end 231 and the bottom conical end 232. In the present application, the bottom edge 234 is located at the middle of the bottom flat end 231 and the conical end 232. As such, when inserting the bottom sound maker 230 to the recess 110 of the body 110, the bottom sound maker 230 could be stuck by the bottom edge 234 without entirely falling into the recess 110.

The bottom cylinder 235 is coupled to the bottom outer body 233 by the at least one bottom connector 236. The bottom cylinder 235 of the present application is hollow. A bottom air flow passage is formed between the bottom cylinder 235 and the sleeve 220. With reference to FIG. 2, the bottom cylinder 235 is matched with the hole 112, allowing the airflow to pass through when the air volume inside the body 100 is changed.

In the present application, the bottom sound maker 230 comprises four bottom connectors 236 as an example but is not limited as long as the bottom cylinder 235 could be coupled to the bottom outer body 233 stably.

In the present application, the bottom outer body 233, the bottom edge 234, the bottom cylinder 235 and the bottom connectors 236 are molded integrally. However, the bottom outer body 233, the bottom edge 234, the bottom cylinder 235 and the bottom connectors 236 could also be manufactured separately and assembled later together, as long as the above structure could be made.

The present application utilizes a mechanical structure rather than an electrical structure to create the sound, greatly reducing the production costs and manufacturing complexity.

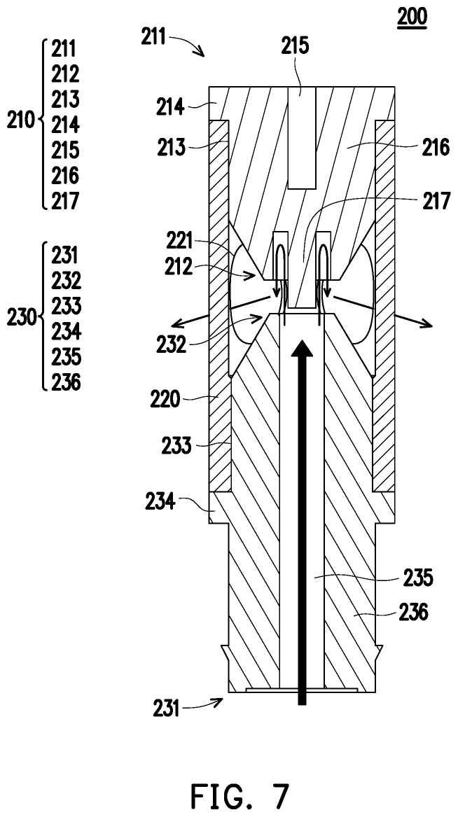

FIG. 7 shows a mechanism of air flowing.

Referring to FIG. 2 and FIG. 7, an air flow is formed when the air inside the body 100 is squeezed. The air flow first passes through the hole 112 of the body 100 and goes into the bottom cylinder 235. The air flow is then separated by the top central rod 217. When reaching the end, the air flow will be bounced back and goes out from the sound generator 200 through the sleeve holes 221.

When loosening the body 100, the air flow will follow the same path but in the opposite direction.

Humans hearing threshold is usually from 20 Hz to 20,000 Hz. However, animals have different hearing thresholds. For example, the hearing threshold of the dogs is usually around 67 Hz to 45,000 Hz, and even could be as high as 100,000 Hz, depending on breeds and ages.

The structure of the pet toy of the present application creates a sound with a frequency over 20,000 Hz via the air flow mechanism of the sound generator 200. More specifically, the frequency of the sound created by the pet toy is over 20,000 Hz and below 45,000 Hz. The frequency of the sound created by the pet toy is higher than humans hearing threshold and only could be heard by animals such as dogs. Also, at a distance of 9.8 inches, the decibel of the created sound could be ignored by the humans, providing a quieter environment for humans.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A pet toy, comprising:
a body comprising at least one body hole; and
a sound generator partially passed through the body hole, wherein the sound generator comprises:
a top sound maker;
a bottom sound maker; and
a sleeve coupled between the top sound maker and the bottom sound maker,
wherein the sound generator is capable of generating sound when air volume inside the body is changed, a frequency of the sound is over 20,000 Hz.

2. The pet toy as claimed in claim 1, wherein the frequency of the sound is over 20,000 Hz and below 45,0000 Hz.

3. The pet toy as claimed in claim 1, wherein the sleeve comprises at least one sleeve hole.

4. The pet toy as claimed in claim 3, wherein the sleeve comprises four sleeve holes.

5. The pet toy as claimed in claim 1, wherein the top sound maker is defined by a top flat end and a top conical end and comprises:
a top outer body;
a top cylinder;
at least one top connector connecting the top outer body and the top cylinder; and
a top central rod coupled to the top cylinder and protruded from the top conical end,
wherein a top airflow passage is formed between the top central rod, the top outer body and the sleeve.

6. The pet toy as claimed in claim 5, wherein the top sound maker comprises four top connectors.

7. The pet toy as claimed in claim 5, wherein the top cylinder is hollow.

8. The pet toy as claimed in claim 5, wherein the top sound maker further comprises a top edge located at the top flat end.

9. The pet toy as claimed in claim 5, wherein the top outer body, the top cylinder, the at least one top connector and the top central rod are molded integrally.

10. The pet toy as claimed in claim 1, wherein the bottom sound maker is defined by a bottom flat end and a bottom conical end and comprises:
a bottom outer body;
a bottom cylinder, wherein the bottom cylinder is hollow, a bottom airflow passage is formed between the bottom cylinder and the sleeve; and
at least one bottom connector connecting the bottom outer body and the bottom cylinder.

11. The pet toy as claimed in claim 10, wherein the bottom sound maker comprises four bottom connectors.

12. The pet toy as claimed in claim 10, wherein the bottom sound maker further comprises a bottom edge located anywhere between the bottom flat end and the bottom conical end.

13. The pet toy as claimed in claim 10, wherein the bottom outer body, the bottom cylinder and the at least one bottom connector are molded integrally.

14. The pet toy as claimed in claim 1, wherein the body comprises a recess.

15. The pet toy as claimed in claim 14, wherein the body comprises one hole located at the recess.

16. The pet toy as claimed in claim 15, wherein the bottom sound maker is located at the recess partially.

17. A sound generator, comprising:
a top sound maker;
a bottom sound maker; and
a sleeve coupled between the top sound maker and the bottom sound maker,
wherein the sound generator is capable of generating sound when air volume inside the body is changed, a frequency of the sound is over 20,000 Hz.

18. The sound generator as claimed in claim 17, wherein the frequency of the sound is over 20,000 Hz and below 45,000 Hz.

19. The sound generator as claimed in claim 17, wherein the top sound maker is defined by a top flat end and a top conical end and comprises:
a top outer body;
a top cylinder;
at least one top connector connecting the top outer body and the top cylinder; and
a top central rod coupled to the top cylinder and protruded from the top conical end,
wherein a top airflow passage is formed between the top central rod, the top outer body and the sleeve.

20. The sound generator as claimed in claim 17, wherein the bottom sound maker is defined by a bottom flat end and a bottom conical end and comprises:
a bottom outer body;
a bottom cylinder, wherein the bottom cylinder is hollow, a bottom airflow passage is formed between the bottom cylinder and the sleeve; and
at least one bottom connector connecting the bottom outer body and the bottom cylinder.
